(19) United States
(12) Patent Application Publication
(10) Pub. No.: US 2018/0338631 A1
(43) Pub. Date: Nov. 29, 2018

(54) FLOOR MAT FASTENING DEVICE

(71) Applicants: Judith Ellis, Payson, AZ (US); Rebecca Orahood, Payson, AZ (US)

(72) Inventors: Judith Ellis, Payson, AZ (US); Rebecca Orahood, Payson, AZ (US)

(21) Appl. No.: 15/862,383

(22) Filed: Jan. 4, 2018

Related U.S. Application Data
(60) Provisional application No. 62/510,341, filed on May 24, 2017.

(51) Int. Cl. A47G 27/04

(52) U.S. Cl. CPC A47G 27/0418; A47G 27/0481

(57) ABSTRACT

A device for coupling at least two floor-mats together on a floor-surface is disclosed herein. The device includes a plate, a first mat fastener, and a second mat fastener. The device is useful for coupling at least two floor-mats together on a floor surface. In a preferred embodiment, the first mat fastener and the second mat fastener may be screws and the screws may be configured to penetrate a thickness of the at least two-floor mats to couple the at least two-floor mats together.

### CROSS REFERENCE TO RELATED APPLICATION

The present application is related to and claims priority to U.S. Provisional Patent Application No. 62/510,341 filed May 24, 2017, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of The Invention

The present invention relates generally to the field of fasteners, and more specifically relates to a device for fastening floor mats together on a floor-surface.

### 2. Description of Related Art

A mat is a piece of fabric material that generally is placed on a floor or other flat surface. Many people place rubber mats in their barn, garage, and other areas around their home. Unfortunately, such mats often curl up around the edges, slide, and shift—especially underneath the weight of horses in barns—causing people and animals to lose their balance, skid, or fall. Additionally, it can be difficult for people to clean mats, as debris can fall in the cracks, adding to their wear and tear.

Holders have been developed to hold the mats in position on the floor, but these holders are not deficient, particularly in horse stables, as the holders protrude over a top surface of the mat, making it difficult to brush or shovel on the mat. Thus, a suitable solution is desired.

U.S. Pat. No. 5,142,733 to Philip Mogel relates to mat holders. The described mat holders include at least one connecting device and at least one connecting member which has complementary connection devices whereby the connecting member may be connected in a releasable manner to at least two adjacent mat holders so as to secure the mat holders together. Preferably at least one of the holders or the connecting members is made from flexible material or is designed to be slightly flexible.

### BRIEF SUMMARY OF THE INVENTION

In view of the foregoing disadvantages inherent in the known fasteners art, the present disclosure provides a novel floor mat fastening device. The general purpose of the present disclosure, which will be described subsequently in greater detail, is to provide a device for fastening at least two floor mats together on a floor-surface.

A device for coupling at least two floor-mats together on a floor-surface is disclosed herein, with, the at least two floor-mats each including a top-surface and a bottom-surface relative the floor-surface, and further including a thickness defined by the top-surface and the bottom-surface. The device includes a plate which may include a flat top-surface and a flat bottom-surface relative the floor-surface, the bottom-surface being configured to rest upon the floor-surface, and the top-surface being configured to rest below each bottom-surface of the at least two floor-mats. Further, the device includes a first mat fastener configured to fasten to the plate and to a first mat of the at least two floor mats, and a second mat fastener configured to fasten to the plate and to a second mat of the at least two floor mats.

A method for coupling at least two floor-mats together on a floor-surface is also disclosed herein, with the at least two floor-mats each including a top-surface and a bottom-surface relative the floor-surface, and further including a thickness defined by the top-surface and the bottom-surface. The method includes the steps of: a providing a device as above; resting the bottom-surface of the plate upon the floor-surface, the plate may have the first mat fastener and the second mat fastener fastened thereto; fastening the first mat fastener to the bottom-surface of the first mat; and fastening the second mat fastener to the bottom-surface of the second mat.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a floor mat coupling device, constructed and operative according to the teachings of the present disclosure.

FIG. 1 is a partial cutaway side view of a floor mat fastening device during an ‘in-use’ condition, according to an embodiment of the disclosure.

FIG. 2A is a perspective view of the device of FIG. 1, according to an embodiment of the present disclosure.

FIG. 2B is a bottom view of the device of FIG. 1, according to an embodiment of the present disclosure.

FIG. 3 is a cutaway side view of the device of FIG. 1, according to an embodiment of the present disclosure.

FIG. 4A is a perspective view of the device of FIG. 1 during an ‘in-use’ condition, according to an embodiment of the present disclosure.

FIG. 4B is a perspective view of a floor mat fastening during an ‘in-use’ condition, according to another embodiment of the present disclosure.

FIG. 5 is a flow diagram illustrating a method of use for device, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a fasteners and more particularly to a floor mat coupling device as used to improve fastening floor mats together.

Generally disclosed is a device to secure four rubber mats together at their corners, or two parallel mats. The device may prevent mats from slipping and sliding under people's feet and may close gaps between mats, preventing debris from building up and collecting in the cracks, thus helping the mat lay flat, especially around their edges.

The device may provide a safe and convenient way to secure four rubber mats together at the corner. The device may include a thin plate, made from metal or other suitable material. In each corner of the plate, there may be a countersunk screw, facing upward. In use, the screw may be placed underneath four rubber mats, gathered at the corners. Each screw may be push upward into the mats without breaking through to the other side of the mats, connecting the mats together. The plate may measure four-inches by four-inches by one-eighth of an inch thick. The device may also include at least 4 screws substantially in each corner of the thin metal plate. The screws may be three-fourths of an inch thick but could be sized and dimensioned to suit a thickness of the mat.

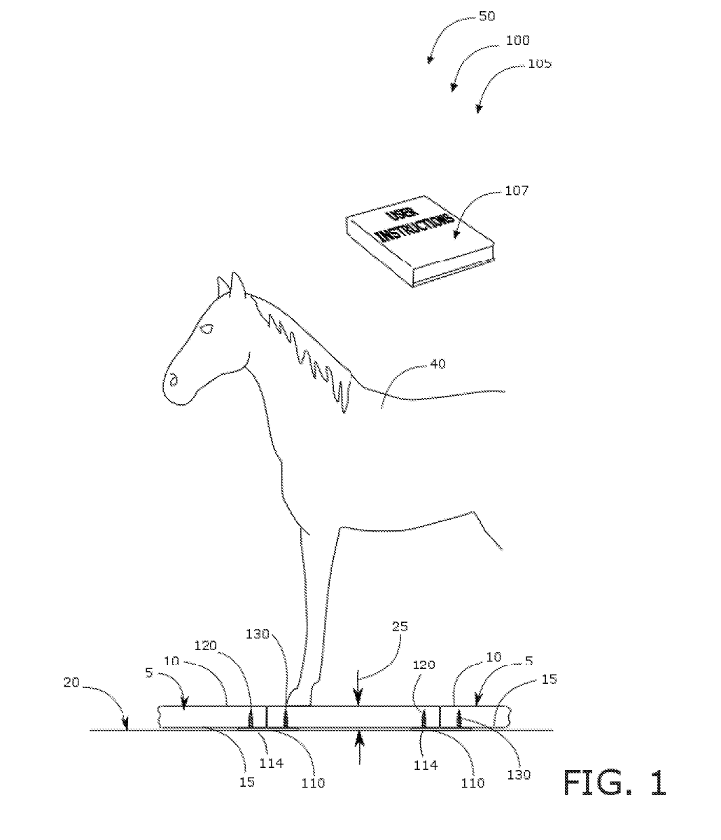

Referring now more specifically to the drawings by numerals of reference, there is shown in FIGS. 1-4B, various views of a device 100.

FIG. 1 shows a device 100 during an ‘in-use’ condition 50, according to an embodiment of the present disclosure. The device 100 may be used for coupling at least two floor-mats 5 together on a floor-surface 20. Each of the at least two floor-mats 5 may include a top-surface 10 and a bottom-surface 15, relative the floor-surface 20, and may further include a thickness 25 that is defined by the top-surface 10 and the bottom-surface 15. As Illustrated, the device 100 may include a plate 110, a first mat fastener 120, and a second mat fastener 130. As shown, the first mat fastener 120 and the second mat fastener 130 may be fixed to the plate 110, extending in an upward direction, relative to the floor-surface 20 when in use. Here, the user 40 is shown to be a horse.

According to one embodiment, the device 100 may be arranged as a kit 105. The kit 105 may include a set of instructions 107. The instructions 107 may detail functional relationships in relation to the structure of the device 100 (such that the device 100 can be used, maintained, or the like, in a preferred manner).

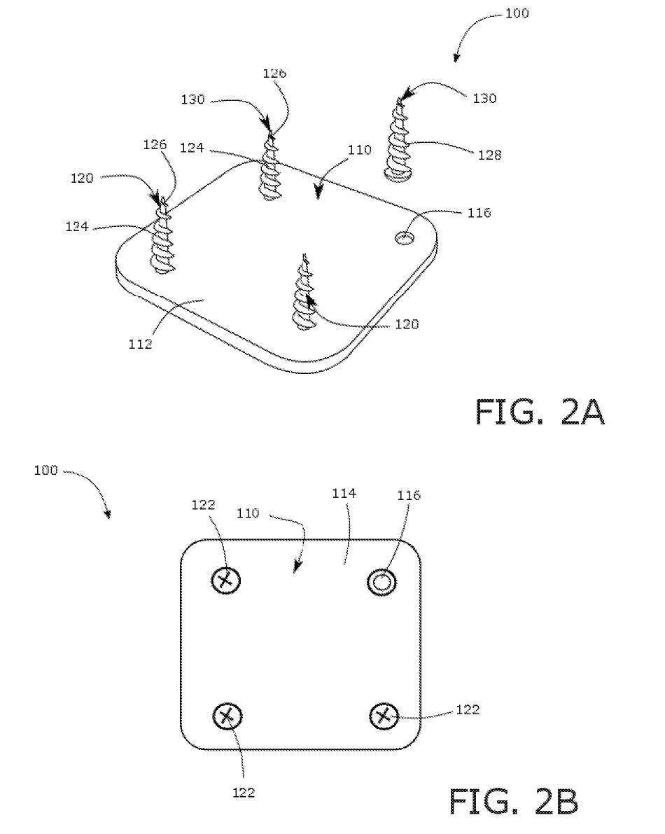

FIG. 2A and FIG. 2B show opposing sides of the device 100, respectively, according to an embodiment of the present disclosure. As shown, the first mat fastener 120 and the second mat fastener 130 may be fixed to the plate 110 in the upward direction, relative the floor-surface 20 (FIG. 1). As shown, the plate 110 may include a flat top-surface 112 and a flat bottom-surface 114 relative the floor-surface 20, the bottom-surface 114 being configured to rest upon the floor-surface 20, and the top-surface 112 being configured to rest below each bottom-surface 10 (FIG. 1) of the at least two floor-mats 5 (FIG. 1).

In a preferred embodiment, the plate 110 may be square-shaped, demonstrated in here. The square-shaped plate 110 may include rounded edges (e.g., about its periphery). According to one embodiment, the plate 110 may be sized and dimensioned to have 1/16 inches in plate thickness 25 (FIG. 1), and 4 inches in length on each plate 110 side. However, the plate 110 may be made in a variety of shapes. For example, in one embodiment, the plate 110 may be rectangular-shaped.

Further, in a preferred embodiment, the plate 110 may be made from metal. Examples of metals include steel, stainless steel, aluminum, titanium, etc. In another embodiment, the plate 110 may be made from a rubber material. In yet another embodiment, the plate 110 may be made from a silicone material.

As shown, the first mat fastener 120 and the second mat fastener 130 may be embodied as screws. Further, the first mat fastener 120 and the second mat fastener 130 may include at least two screws, may include four screws, or more. Similarly, the plate 110 may include four corners, and each of the four screws may be located at one of the four corners. In other embodiments, the first mat fastener 120 and the second mat fastener 130 might not be screws. Examples of other first mat fasteners 120 and second mat fasteners 130 contemplated include: hook and loop fasteners, industrial snap fasteners, adhesives, or the like. Examples of adhesives may include cyanoacrylate, a cement, a paste, or the like.

According to one embodiment the bottom-surface 114 of the plate 110 may include at least two countersink holes 116 at the opposing ends. In this embodiment, the at least two screws may be countersunk screws configured to seat flush into the bottom-surface 114 of the plate 110 via each screw-head 122. As illustrated, the at least two countersink holes 116 may be four countersink holes 116 located at the four corners.

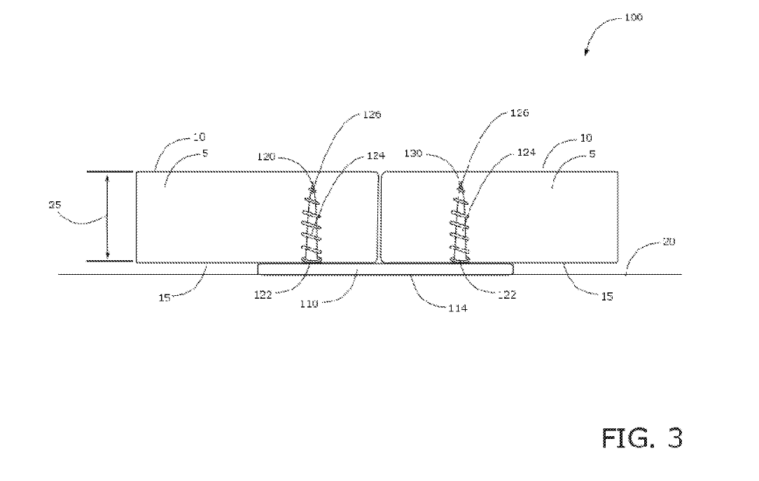

FIG. 3 is a cutaway view of the device 100, according to an embodiment of the present disclosure, illustrating the thickness 25 of the at least two floor-mats 5 in comparison to a length of the screw-shank 124. As shown, the first mat fastener 120 may be configured to fasten to the plate 110 and to a first mat of at least two floor-mats 5, and the second mat fastener 130 may be configured to fasten to the plate 110 and to a second mat of the at least two floor-mats 5.

The first mat fastener 120 and the second mat fastener 130 may each be made from a stainless steel. In a preferred embodiment, the first mat fastener 120 and the second mat fastener 130 may be screws, each including a screw-head 122, a screw-shank 124, and a screw-point 126, respectively, and each screw-point 126 being configured to penetrate the bottom-surface 15 of one of the at least two floor-mats 5. Further, each screw may be coupleable to an opposing end of the plate 110 via its screw-head 122, and oriented vertically relative the floor-surface 20.

Each screw may be sized and dimensioned to extend through at least half the thickness 25 of one of the at least two floor-mats 5 without penetrating the top-surface 10 of the one of the at least two floor-mats 5 while in use. For example, when the at least two floor-mats 5 have a thickness 25 of 1 inch, the screw-shank 124 of each screw may be at least 0.5 inches.

In other embodiments, each screw may be sized and dimensioned to extend through at least 0.75 of the thickness 25 of one of the at least two floor-mats 5. For example, where the at two least floor-mats 5 have a thickness 25 of 1 inch, the screw-shank 124 of each screw may be at least 0.75 inches. It should be appreciated that each screw may be sized and dimensioned in a variety of sizes, however, each screw should be sized and dimensioned such that the screw-point 126 does not penetrate the top-surface 10 of its respective floor-mat 5, and such that the screw-shank 124 has the length sufficiently long enough to pierce through the thickness 25 of the one of the at least two floor-mats 5 in order to securely couple each screw to the one of the at least two floor-mats 5.

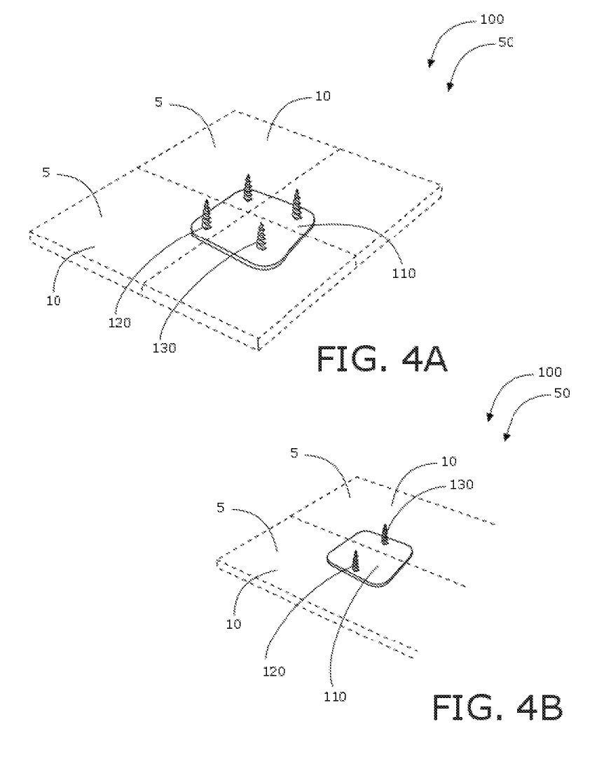

FIG. 4A is a perspective view of the device 100 of FIG. 1 during an ‘in-use’ condition, according to the preferred embodiment of the present disclosure. The device 100 is shown underneath the floor-mats 5, and illustrates an exemplary coupling location of the first mat fastener 120 and the second mat fastener 130. As above, the at least two screws may include four screws, the plate 110 may include four corners, and each of the four screws may be located at one of the four corners. Further, as shown in this figure, the at least two-floor mats 5 may include four floor-mats. In the preferred embodiment, each of the four floor-mats may be fastened to one of each of the four screws (as demonstrated).

FIG. 4B is a perspective view of a floor mat fastening during an ‘in-use’ condition, illustrating an alternative embodiment of the present disclosure. Here, the plate 110 has a rectangular shape including two ends, with the first mat fastener 120 attached to one end, and the second mat fastener 130 attached to the second end. In this embodiment, the device 100 is shown coupling two floor-mats 5 together at their sides.

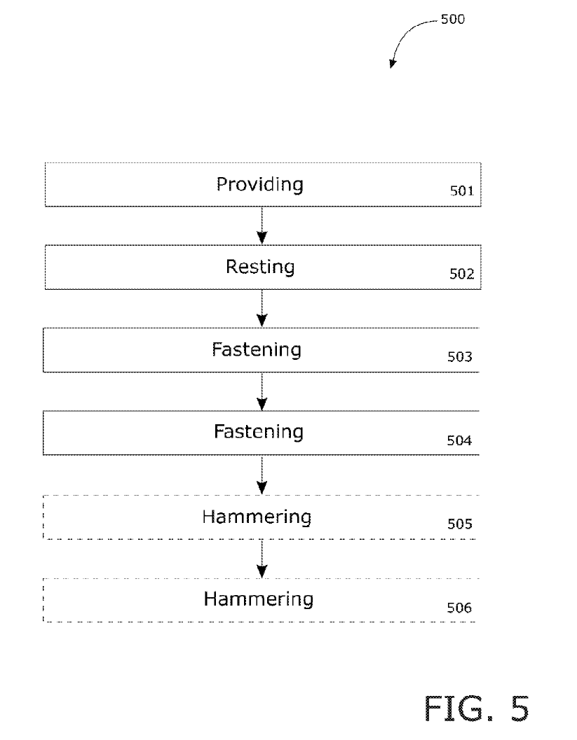

FIG. 5 is a flow diagram illustrating a method for coupling at least two floor-mats together on a floor-surface (“method” 500), according to an embodiment of the present disclosure. As illustrated, the method 500 may include the steps of: step one 501, providing the device 100 as described above; step two 502, resting the bottom-surface of the plate 110 upon the floor-surface 20, the plate 110 having the first mat fastener 120 and the second mat fastener 130 fastened thereto; step three 503, fastening the first mat fastener 120 to the bottom-surface of the first mat; step four 504, fastening the second mat fastener 130 to the bottom-surface of the second mat. The method 500 may further include the steps of: step five 505, hammering the top-surface of the first mat to force the first mat fastener 120 into the first floor-mat against the floor-surface 20; and step six 506, hammering the top-surface of the second mat to force the second mat fastener 130 into the second floor-mat against the floor-surface 20.

It should be noted that step five 505 and step six 506 are optional steps and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for device 100 (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

1. A device for coupling at least two floor-mats together on a floor-surface, the at least two floor-mats each including a top-surface and a bottom-surface relative the floor-surface, and further including a thickness defined by the top-surface and the bottom-surface, the device comprising:
a plate including a flat top-surface and a flat bottom-surface relative the floor-surface, the bottom-surface being configured to rest upon the floor-surface, and the top-surface being configured to rest below each bottom-surface of the at least two floor-mats;
a first mat fastener configured to fasten to the plate and to a first mat of the at least two floor mats; and
a second mat fastener configured to fasten to the plate and to a second mat of the at least two floor mats.

2. The device of claim 1, wherein the first mat fastener and the second mat fastener are screws, each including a screw-head, a screw-shank, and a screw-point, respectively, each screw-point configured to penetrate the bottom-surface of one of the at least two floor-mats, each screw coupleable to an opposing end of the plate via its screw-head, and oriented vertically relative the floor-surface.

3. The device of claim 2, wherein each screw is sized and dimensioned to extend through at least half the thickness one of the at least two floor-mats without penetrating the top-surface of the one of the at least two floor-mats while in use.

4. The device of claim 2, wherein the bottom-surface of the plate includes at least two countersink holes at the opposing ends; and
wherein the at least two screws are countersunk screws configured to be fixedly attached to the top-surface of the plate via each screw-head.

5. The device of claim 2, wherein the at least two screws include four screws.

6. The device of claim 5, wherein the plate has four corners, and each of the four screws is located at one of the four corners.

7. The device of claim 6, wherein the at least two countersink holes are four countersink holes located at the four corners; and
wherein the four screws are four countersunk screws configured to be fixedly attached to the bottom-surface of the plate and to seat flush with the bottom-surface of the plate via each screw-head, respectively.

8. The device of claim 1, wherein the at least two-floor mats include four floor-mats.

9. The device of claim 1, wherein the plate is rectangular-shaped.

10. The device of claim 9, wherein the plate is square-shaped.

11. The device of claim 10, wherein the plate is 1/16 inches in plate thickness, 4 inches in length on each plate side.

12. The device of claim 1, wherein the plate is made from a metal.

13. The device of claim 1, wherein the plate is made from a rubber.

14. The device of claim 1, wherein the first mat fastener and the second mat fastener are each made from a stainless steel.

15. The device of claim 1, wherein the first mat fastener and the second mat fastener are fixed to the plate, extending in an upward direction, relative to the floor-surface when in use.

16. A device for coupling at least two floor-mats together on a floor-surface, the at least two floor-mats each including a top-surface and a bottom-surface relative the floor-surface, and further including a thickness defined by the top-surface and the bottom-surface, the device comprising:
a plate including a flat top-surface and a flat bottom-surface relative the floor-surface, the bottom-surface being configured to rest upon the floor-surface, and the top-surface being configured to rest below each bottom-surface of the at least two floor-mats;
a first mat fastener configured to fasten to the plate and to a first mat of the at least two floor mats; and
a second mat fastener configured to fasten to the plate and to a second mat of the at least two floor mats; and
wherein the first mat fastener and the second mat fastener are screws, each including a screw-head, a screw-shank, and a screw-point, respectively, each screw-point configured to penetrate the bottom-surface of one of the at least two floor-mats, each screw coupleable to an opposing end of the plate via its screw-head, and oriented vertically relative the floor-surface;
wherein each screw is sized and dimensioned to extend through at least half the thickness one of the at least two floor-mats without penetrating the top-surface of the one of the at least two floor-mats while in use;
wherein the bottom-surface of the plate includes at least two countersink holes at the opposing ends;
wherein the at least two screws are countersunk screws configured to be fixedly attached to the top-surface of the plate via each screw-head;
wherein the at least two screws include four screws;
wherein the plate has four corners, and each of the four screws is located at one of the four corners;
wherein the at least two-floor mats include four floor-mats;
wherein the plate is square-shaped;
wherein the plate is 1/16 inches in plate thickness, 4 inches in length on each plate side;
wherein the plate is made from a metal;
wherein the first mat fastener and the second mat fastener are each made from a stainless steel; and
wherein the first mat fastener and the second mat fastener are fixed to the plate, extending in an upward direction, relative to the floor-surface when in use.

17. The device of claim 16, further comprising set of instructions; and
wherein the device is arranged as a kit.

18. A method for coupling at least two floor-mats together on a floor-surface, the at least two floor-mats each including a top-surface and a bottom-surface relative the floor-surface, and further including a thickness defined by the top-surface and the bottom-surface, the method comprising the steps of:
providing a device including
a plate having a flat top-surface and a flat bottom-surface relative the floor-surface, the bottom-surface being configured to rest upon the floor-surface, and the top-surface being configured to rest below each bottom-surface of the at least two floor-mats,
a first mat fastener configured to fasten to the plate and to a first mat of the at least two floor mats, and
a second mat fastener configured to fasten to the plate and to a second mat of the at least two floor mats;
resting the bottom-surface of the plate upon the floor-surface, the plate having the first mat fastener and the second mat fastener fastened thereto;
fastening the first mat fastener to the bottom-surface of the first mat; and
fastening the second mat fastener to the bottom-surface of the second mat.

19. The method of claim 18, wherein the fastening the first mat fastener to the bottom-surface of the first mat includes hammering the top-surface of the first mat to force the first mat fastener into the first floor-mat against the floor-surface; and
wherein the fastening the second mat fastener to the bottom-surface of the second mat includes hammering the top-surface of the second mat to force the second mat fastener into the second floor-mat against the floor-surface.
